(19) United States
(12) Patent Application Publication
(10) Pub. No.: US 2022/0210034 A1
(43) Pub. Date: Jun. 30, 2022

(54) SYSTEMS AND METHODS FOR EDGE SITE SELECTION AND METRICS CAPTURE

(71) Applicant: CenturyLink Intellectual Property LLC, Broomfield, CO (US)

(72) Inventors: William R. Benassi, Oak River, MN (US); William O'Brien, Aurora, CO (US)

(73) Assignee: CenturyLink Intellectual Property LLC, Broomfield, CO (US)

(21) Appl. No.: 17/565,053

(22) Filed: Dec. 29, 2021

Related U.S. Application Data
(63) Continuation-in-part of application No. 17/476,708, filed on Sep. 16, 2021.
(60) Provisional application No. 63/132,611, filed on Dec. 31, 2020.
(60) Provisional application No. 63/138,919, filed on Jan. 19, 2021.

(51) Int. Cl. H04L 43/04; H04L 43/02; H04L 41/084; H04L 41/0853

(52) U.S. Cl. CPC H04L 43/04; H04L 41/0853; H04L 41/0843; H04L 43/02

(57) ABSTRACT

Systems and methods for metrics capture and use in a computing network are provided. In examples, systems and methods are provided to permit network elements (such as network devices and workloads) to be instrumented for metrics collection as part of the process of provisioning the network element on the network. In examples, a collection template is provided to a customer that can be used to generate a collection component for collecting metrics associated with the network element. In examples, the collected metrics can be stored and used by an edge recommendation system to determine one or more recommended edge sites at which the network element should be placed according to optimization criteria.

### RELATED APPLICATION(S)

This application claims the benefit of provisional U.S. Patent Application Ser. No. 63/132,611, entitled “SYSTEM TO DETERMINE BEST NODE FOR EDGE COMPUTING,” filed Dec. 31, 2020. This application is a Continuation-in-Part of U.S. patent application Ser. No. 17/476,708, entitled “OBJECT-ORIENTED INFRASTRUCTURE-AS-CODE PLATFORM (OOIACP),” filed Sep. 16, 2021, which claims benefit of provisional U.S. Patent Application Ser. No. 63/138,919, filed Jan. 19, 2021, entitled, “OBJECT-ORIENTED INFRASTRUCTURE-AS-CODE PLATFORM (OOIACP),” all of which applications are incorporated by reference in their entireties for all that they teach. To the extent appropriate, a claim of priority is made to each of the above-described applications.

### BACKGROUND

Computing networks are increasingly large and complex. Customers of computing networks may desire to instantiate certain network elements (such as network devices or workloads) at different places within the computing network based on a variety of factors. Determining an optimal position within a network to instantiate a particular component may require knowledge of network performance. It is with respect to this general environment that aspects of the present application are directed.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Aspects of the present application comprise a method, wherein the method includes receiving, at a network utility and from a client device, a first request to configure a network element at a first network edge site for a first customer, wherein the first network element comprises at least one of a first network device and a first workload. The method continues by sending, by the network utility, at least a first configuration file for the first network element, wherein the first configuration file comprises a first capture template for metrics collection. The method further includes configuring the first network element at the first network edge site, including a first capture component that comprises a refactored first capture template, and receiving, at a metrics storage system, instances of metrics from the first capture component of the first network element. Further, the method may comprise receiving a request for the metrics at the metrics storage system; and providing the instances of the metrics.

In other aspects, the present application describes another method that includes receiving, from a first client device, a first request to recommend a network edge site within a provider network to configure a first network element for a first customer, wherein the first network element comprises at least one of a first network device and a first workload, and wherein the request includes first component information and first optimization criteria. The method continues with determining, based on the first component information and the first optimization criteria, first relevant metrics, and querying a metrics storage system for the first relevant metrics, wherein the metrics storage system stores instances of the first relevant metrics from other network elements operating on the provider network. The method continues by receiving the instances of the first relevant metrics, using the instances of the first relevant metrics to generate a recommendation of at least a first network edge site for the first network element, and providing the recommendation to the first client device.

In another aspect, the present application discloses a system comprising at least one processor; and memory, operatively connected to the at least one processor and storing instructions that, when executed by the at least one processor, cause the system to perform a method. In aspects, the method comprises receiving, at a network utility and from a client device, a first request to configure a network element at a first network edge site within a provider network for a first customer, wherein the first network element comprises at least one of a first network device and a first workload. The method further includes sending, by the network utility, at least a first configuration file for the first network element, wherein the first configuration file comprises a first capture template for metrics collection, and configuring the first network element at the first network edge site, including a first capture component that comprises a refactored first capture template. Further, the method may comprise storing, at a metrics storage system, instances of first metrics from the first capture component of the first network element, and receiving, from a second client device, a request to recommend a network edge site within the provider network to configure a second network element for a second customer, wherein the second network element comprises at least one of a second network device and a second workload, and wherein the request to recommend includes component information and optimization criteria. The method further includes determining, based on the component information and the optimization criteria, relevant metrics, querying the metrics storage system for the relevant metrics, and receiving the instances of the relevant metrics. The method may also include using the instances of the relevant metrics to generate a recommendation of at least a second network edge site for the second network element; and providing the recommendation to the second client device.

### BRIEF DESCRIPTION OF THE DRAWINGS

Non-limiting and non-exhaustive examples are described with reference to the following figures.

FIG. 1 depicts an example system according to aspects of the present application.

FIG. 2 depicts another example system according to aspects of the present application.

FIG. 3 depicts and example method according to aspects of the present application.

FIG. 4 depicts another example method according to aspects of the present application.

FIG. 5 depicts an example computing environment that can be used with aspects of the present application.

### DETAILED DESCRIPTION

In examples, the present application describes systems and methods for metrics capture and use in a computing network. In examples, systems and methods are provided to permit network elements (such as network devices and workloads) to be instrumented for metrics collection as part of the process of provisioning the network element on the network. In examples, a collection template is provided to a customer that can be used to generate a collection component for collecting metrics associated with the network element. In examples, the collected metrics can be stored and used by an edge recommendation system to determine one or more recommended edge sites at which the network element should be placed according to optimization criteria.

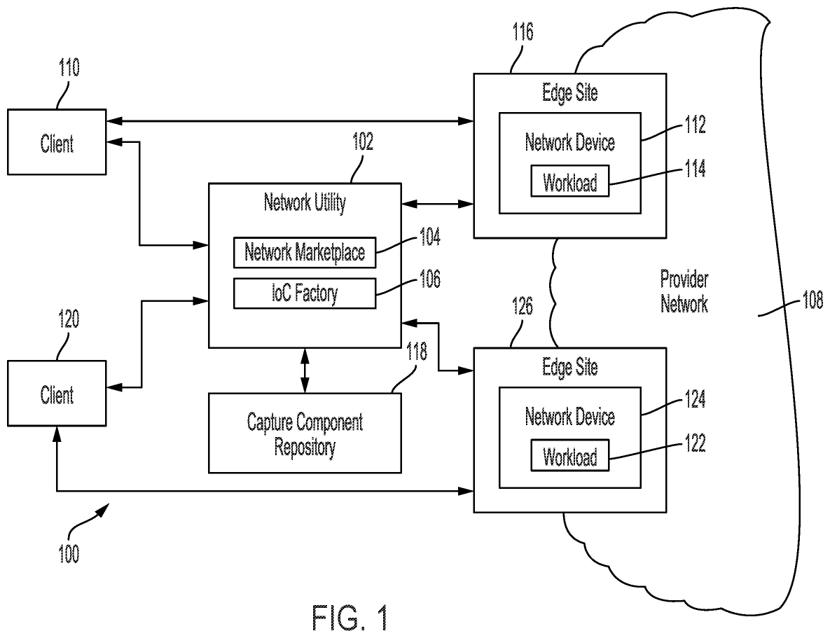

Referring to the example system 100 in FIG. 1, a network utility 102 is provided. In examples, the network utility 102 comprises a network marketplace 104 and an Internet of Components factory 106. The network marketplace 104 may comprise a system to permit customers to discover and order services from a provider network 108. In examples, a customer may access the network utility 102 in order to provision a network element at an edge site (also referred to as an edge node). For example, client device 110 may be used to deploy a network element (such as a network device 112 or workload 114) on edge site 116 of provider network 108 for a customer's use.

For example, provider network 108 may comprise routers, switches, gateway devices, data storage devices, servers, and other computing devices. In examples, the provider network 108 may also comprise a plurality of edge sites 116, 126, which may provide computing capability for use by customers of the provider network 108. Although two edge sites are depicted, any number of provider sites may be provided. In examples, edge sites 116, 126 are located at or near the edge of provider network 108. For example, provider sites 116, 126 may each include at least one provider edge router, which operates as an ingress point into provider network 108 for communications from customer site(s), e.g., where client devices 110 and 120 may reside. Customer site(s) may be geographically dispersed for a variety of customers. In addition, a single customer may have multiple, geographically dispersed customer site(s). Edge sites 116, 126 may also include computing capabilities (e.g., servers) and data storage to permit the edge sites 116, 126 to host computing services. Edge sites 116, 126 may be operatively connected to customer site(s) through a variety of other networks or communication links, including private networks, public networks, and/or a hybrid of public and private networks. In examples, having edge sites 116, 126 at or near the edge of provider network 108 permit the customer site(s) to minimize latency (among other things), particularly when the edge site is selected, in part, based on the proximity of that provider site to the customer site(s) that need access to the provider site. In addition, the edge sites 116, 126 may not be uniform—e.g., they may differ in computing capability, security certification, capacity for expansion, data storage availability, type of network connectivity (e.g., public internet, private networking, hybrid public/private), etc. Accordingly, selection of an edge site 116, 126 for particular network element (e.g., network device or workload) to be hosted for access by customer site(s) may be optimized based on a variety of factors.

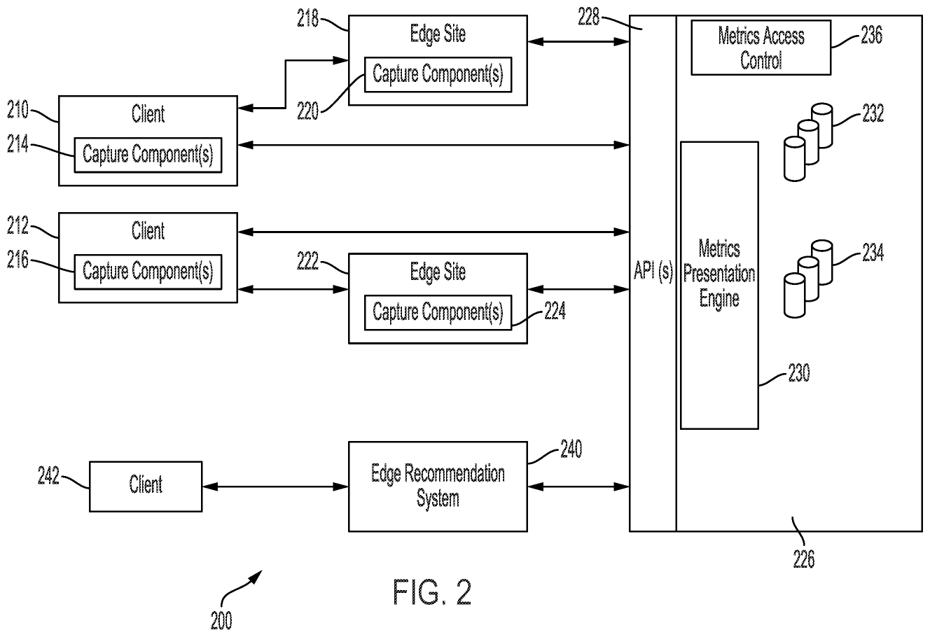

In examples, client device 110 may access the network marketplace 104 and indicate that a first customer (e.g., using client device 110) desires to provision network device 112 and/or workload 114 at edge site 116. Edge site 116 may be selected, e.g., by the first customer using an edge site recommendation system discussed below in relation to FIG. 2. The network marketplace 104 may, among other things, reserve network resources for the network element. For example, the network marketplace 104 (or another element of network utility 102) may provision the network device, reserve one or more IP addresses, assign virtual local area networks (VLANs), etc. The network marketplace 104 may also redirect the client device 110 to the IoC factory 106 to configure the network element.

IoC factory may be an object, function, or method in a programming environment within the network utility 102. The IoC factory 102 may provide an “API-First” implementation of well-known patterns and underlying automation that can be standardized on to lifecycle and operate IaC (Infrastructure as Code) component infrastructure and/or their workloads at scale. It may be complementary to an off-the-shelf self-service cloud-management platform system, such as Morpheus (available from Morpheus Data, LLC).

The IoC factory 106 may act as an API provisioning server behind the network marketplace 104, where “products” are well defined and offer push button automation at scale for ongoing custom provisioning in multiple use cases. The IoC factory 106 may employ a marketplace metaphor whose hierarchy is product suite (i.e., the domain), product (i.e., the deliverable) and product option (i.e., customizations to the deliverable). In examples, the IoC factory can provision APIs required for metric collection while provisioning a network element, thereby allowing the network element to be automatically instrumented for metrics collection when lifecycled from the IoC factory. Examples of an IoC factory 106 are described in U.S. patent application Ser. No. 17/476,708, which is incorporated by reference herein for all that it teaches.

For example, the network utility may receive from client 110 the selection of a particular network element from the network marketplace 104. The IoC factory may be configured to select from the capture component repository 118 one or more capture templates. In examples, the capture templates in capture component repository 118 may comprise default templates (e.g., for all runnables) or may be templates that have been previously refactored and/or used for the particular type of network element selected from the network marketplace 104.

In an example, the network utility 102 receives a selection from client 110 of a particular workload 114 (e.g., application) from the network marketplace 104 that a first customer wants provisioned to network device 112 at edge site 116. The IoC factory 106 may provide the client with default capture template(s) and/or capture template(s) from the capture component repository 118 that have been customized for that type of workload 114. The IoC factory 106 may provide the capture template(s) to the client device 110.

In examples, the client device 110 may then be used to refactor the capture template to customize the metrics that will be captured by a capture component associated with workload 114. For example, the capture template may include a command line runner and an instrumentation template. An excerpt from an example capture template for a REST-ful create, retrieve, update, delete, list, and bulk write (CRUDLB) API is shown below.

| | |
|---|---|
| // | @Bean |
| // | public RestTemplate restTemplate(RestTemplateBuilder builder) { |
| // | return builder.build( ); |
| // | } |
| // | // Edge Metrics Ecosystem CRUDLB Metrics Calls |
| // | @Bean |
| // | public CommandLineRunner run(RestTemplate restTemplate) throws Exception { |
| // | return args −> { |
| // | int x = 0; |
| // | while (x != 1) { |
| // | // Create Template |
| // | LOG.info(“ ”); |
| // | LOG.info(“**********Executing the CREATE API**********”)_{;} |
| // | ioCFactoryProductCrudlbCreatePojo |

newIoCFactoryProductCrudlbCreatePojo = new
IoCFactoryProductCrudlbCreatePojo(iocFactoryProductCrudlbSolutionMal,
iocFactoryProductCrudlBSolutionDb, iocFactoryProductCrudlbSolutionCreateQuery);

| | |
|---|---|
| // | String iocFactoryProductCrudlbCreateReply= |

restTemplate.postForObject(

| | |
|---|---|
| // | iocFactoryProductCrudlbSolutionCreateUri, |

newIoCFactoryProductCrudlbCreatePojo, String.class);

| | |
|---|---|
| // | LOG.info(iocFactoryProductCrudlbCreateReply); |
| // | // Retrieve Template |
| // | LOG.info(“**********Executing the RETRIEVE API**********”); |
| // | IoCFactoryProductCrudlbRetrievePojo |

newIoCFactoryProductCrudlbRetrievePojo = new
IoCFactoryProductCrudlbRetrievePojo(iocFactoryProductCrudlbSolutionMal,
iocFactoryProductCrudlbSolutionDb, iocFactoryProductCrudlbSolutionRetrieveQuery);

| | |
|---|---|
| // | String iocFactoryProductCrudlbRetrieveReply = |

restTemplate.postForObject(

| | |
|---|---|
| // | iocFactoryProductCrudlbSolutionRetrieveUri, |

newIoCFactoryProductCrudlbRetrievePojo, String.class);

| | |
|---|---|
| // | LOG.info(iocFactoryProductCrudlbRetrieveReply); |
| // | |

// Update Template

| | |
|---|---|
| // | LOG.info(“**********Executing the UPDATE API**********”); |
| // | IoCFactoryProductCrudlbUpdatePojo |

newIoCFactoryProductCrudlbUpdatePojo = new
IoCFactoryProductCrudlbUpdatePojo(iocFactoryProductCrudlbSolutionMal,
iocFactoryProductCrublbSolutionDb, iocFactoryProductCrublbSolutionUpdateQuery);

| | |
|---|---|
| // | String iocFactoryProductCrublbUpdateReply = |

restTemplate.postForObject(

| | |
|---|---|
| // | iocFactoryProductCrublbSolutionUpdateUri, |

newIoCFactoryProductCrublbUpdatePojo, String.class);

| | |
|---|---|
| // | LOG.info(iocFactoryProductCrublbUpdateReply); |

// Delete Template

| | |
|---|---|
| // | LOG.info(“**********Executing the DELETE API**********”); |
| // | IoCFactoryProductCrublbDeletePojo |

newIoCFactoryProductCrublbDeletePojo = new
IoCFactoryProductCrublbDeletePojo(iocFactoryProductCrublbSolutionMal,
iocFactoryProductCrublbSolutionDb, iocFactoryProductCrublbSolutionDeleteQuery);

| | |
|---|---|
| // | String iocFactoryProductCrublbDeleteReply = |

restTemplate.postForObject(

| | |
|---|---|
| // | iocFactoryProductCrublbSolutionDeleteUri, |

newIoCFactoryProductCrublbDeletePojo, String.class);

| | |
|---|---|
| // | LOG.info(iocFactoryProductCrublbDeleteReply); |
| | // List Template |
| // | LOG.info(“**********Executing the LIST DBs API**********”); |
| // | IoCFactoryProductCrublbListPojo |

newIoCFactoryProductCrublbListPojo = new
IoCFactoryProductCrublbListPojo(iocFactoryProductCrublbSolutionMal,
iocFactoryProductCrublbSolutionListQuery);

| | |
|---|---|
| // | String iocFactoryProductCrublbListReply = |

restTemplate.postForObject(

| | |
|---|---|
| // | iocFactoryProductCrublbSolutionListUri, |

newIoCFactoryProductCrublbListPojo, String.class);

| | |
|---|---|
| // | LOG.info(iocFactoryProductCrublbListReply); |
| // | |
| | // Get Collection Names Template |
| // | LOG.info(“**********Executing the LIST COLLECTIONS |

API**********”;

| | |
|---|---|
| // | IoCFactoryProductCrublbGetCollectionNamesPojo |

newIoCFactoryProductCrublbGetCollectionNamesPojo = new
IoCFactoryProductCrublbGetCollectionNamesPojo(iocFactoryProductCrublbSolutionMal,
iocFactoryProductCrublbSolutionDb,
iocFactoryProductCrublbSolutionGetCollectionNamesQuery);

| | |
|---|---|
| // | String iocFactoryProductCrublbGetCollectionNamesReply = |

restTemplate.postForObject(

| | |
|---|---|
| // | iocFactoryProductCrublbSolutionGetCollectionNamesUri, |

newIoCFactoryProductCrublbGetCollectionNamesPojo, String.class);

| | |
|---|---|
| // | LOG.info(iocFactoryProductCrublbGetCollectionNamesReply); |
| | // Bulk Write Template |
| // | LOG.info(“**********Executing the BULK WRITE API**********”); |
| // | IoCFactoryProductCrublbBulkWritePojo |

newIoCFactoryProductCrublbBulkWritePojo = new
IoCFactoryProductCrublbBulkWritePojo(iocFactoryProductCrublbSolutionMal,
iocFactoryProductCrublbSolutionDb, iocFactoryProductCrublbSolutionBulkWriteQuery);

| | |
|---|---|
| // | String iocFactoryProductCrublbBulkWriteReply = |

restTemplate.postForObject(

| | |
|---|---|
| // | iocFactoryProductCrublbSolutionBulkWriteUri, |

newIoCFactoryProductCrublbBulkWritePojo, String.class);

| | |
|---|---|
| // | LOG.info(iocFactoryProductCrublbBulkWriteReply); |

The capture template can be refactored for particular, desired metrics capture (e.g., by client device 110) and the refactored template (now a capture component) can be deployed with the workload 114 (e.g., as a fat war or jar on within a command line interface, or otherwise). The frequency with which the capture component will capture metrics can also be customized, e.g., by a frequency criterion or time-of-day criterion, as non-exclusively shown below:

```
        // Publish Performance Metrics per Frequency Criteria
//  if (1 = = 1) {
//
            // Retrieve Circuit Serial Numbers from GLB
            // Determine Node URI and Port
            // Metric Each Node (first ICMP and then /ping if such
unavailable)
            // Batch Circuit Results
            // Commit Circuit Results to Edge Metrics Ecosystem
            // Commit Other Results “Alarm” Annotated to Edge Metrics
Ecosystem
// }
        // Publish Inventory Metrics per Time of Day Criteria Once a Day
// if (1 = = 1){
            // Retrieve Inventory
            // Publish Inventory
//  }
//  };
//  };
// }
}
```

Further, a customer may delineate for particular metrics, access controls for the metrics that are captured using the capture component. In some examples, metrics may be available to any client process that requests them. In other examples, the metrics (once captured) may be accessed only by client processes that have permission to do so (e.g., using role-based access control (RBAC) or otherwise). In some examples, certain metrics may be mandatorily required by the provider network 108 to be accessible at least to certain client processes, such as an edge recommendation system described below. In other examples, certain metrics may be kept private and accessible only to the customer that provisions the network element with which the capture component is provisioned. In examples, captured metrics may be anonymized before being made available to any metrics-consuming process or system.

In addition, per configuration each runnable has metrics capture built in and may set a scope per an environment variable to define capture metrics exchange between it and other runnables (“the circuit”) so as to measure latency and/or other defined metrics developed in the future. If “public” is defined, metrics are empirically collected with every other “public” configured runnable in the domain (as specified in $BODY of the REST call and acted upon by, e.g., a global load balancer) and thus represents a “closed circuit.” By simply instantiating as public they will automatically participate in metrics collection of all metrics (e.g., latencies) in the public circuit. Alternatively, each runnable may instead specify a set of serial numbers representing the runnables they wish to be in closed circuit with.

In the public configuration, each runnable will automatically instantiate a metrics database (discussed below) in their chosen target domain by simply calling the CREATE in the CRUDLB REST API that in turn uses the database command line interface, named after its serial number, which will record said metric with every other runnable in the closed circuit. Likewise, the peer runnables will do the same for non-public. When later queried for metrics presentation, if all runnables in the circuit are still configured with the circuit still being closed, the metrics data will be returned. If not, the metrics data will not be returned. Ultimately, to facilitate the closed circuit, the runnable data glyph will have in it its IP address and port that can be decoded by the other runnables in the circuit to collect latency metrics via internet control message protocol (ICMP).

In examples, the network utility 102 may operate to allow other clients to provision and configure additional network elements at different edge sites within the provider network 108. For example, client device 120 may also use network utility 102 to provision a different workload 122 on a network device 124 at edge site 126. In examples, if the workload 122 is of a different type from workload 114, the capture template(s) returned by network utility 102 to client device 120 may be different from the capture template(s) returned by network utility 102 to client device 110. For example, workload 122 may be a different application from workload 114, and the capture template for an application of similar type to workload 122 may have been previously customized and stored within capture component repository 118. Accordingly, the appropriate template for that workload 122 may be retrieved and returned to client device 120. In other examples, default capture template(s) are returned instead of or in addition to the capture template for a workload of particular type.

In some examples, the network element being provisioned may be an infrastructure component rather than a workload. For example, if network utility 102 receives an indication that a customer (e.g., a second customer using client device 120) desires to provision a new server (e.g., network device 124), then the network utility 102 may return a capture agent template from repository 118 to client device 120. A capture agent may be run as a standalone agent (as opposed to being embedded in a workload, such as workload 122). The capture agent template may also then be refactored/customized (e.g., by client device 120) to create a capture component that is provisioned/configured with network device 124.

In examples, the capture template may be returned to a client device (e.g., client device 120) by network utility 102 as part of a configuration file. Configuration file, as used herein, is broadly defined as one or more provisioning template(s) that can be used by the client device in order to provision the network element (e.g., workload 122 or network device 124) on an edge site (e.g., edge site 126) of provider network 108. In examples, by including a capture template in the provisioning process for the network element, metrics capture is automatically (and as a default) included in the provisioning of all network elements. This promotes consistency and eliminates the need to keep a separate metrics collection system in synch with workload maintenance (because the metrics collection is part of the workload). It is also noted that, although certain examples are discussed herein the capture template as being retrieved by the IoC factory 106, it is also possible to make the capture component repository 118 available to client devices 110, 120 without using the IoC factory.

Further, in some examples, one or more capture components may be implemented on client devices (e.g., client devices 110, 120, or other client devices that access the workloads 114, 122 and/or network devices 112, 124). For example, in some instances, metrics may be desired to be captured on customer-premise machines. Capture components that are instrumented as described herein may also be deployed on such client devices, as well as on devices that are operating on edge sites 116, 126. Further, although examples are described herein within an edge computing system, examples of the metrics capture systems described herein can be used in any computing network.

FIG. 2 depicts an example system 200 for collecting and presenting metrics in an edge computing environment. In examples, client devices 210, 212 are instrumented with capture component(s) 214, 216, respectively, e.g., using the systems and methods described above with respect to system 100. In examples, client device 210 may execute a client workload that cooperates with a workload on edge computing site 218. For example, edge site 218 may be edge site 116 from FIG. 1, and edge site 218 may comprise network device 112 running workload 114. In an example, network device 112 and workload 114 at edge site 218 may be instrumented with capture components 220, as described above. Similarly, edge site 222 may comprise edge site 126 from FIG. 1 and may comprise network device 124 and workload 122 instrumented with capture component(s) 224.

As discussed above, the capture components 214, 216, 220, and 224 may be instrumented to transmit instances of metrics into a metrics storage system 226. The metrics storage system 226 may comprise one or more APIs 228 fronting a metrics presentation engine 230. Metrics storage system 226 may also comprise a plurality of metrics databases (or database clusters) 232, 234. In addition, access to metrics stored at metrics storage system 226 may be controlled in part by a metrics access control system 236.

In examples, metrics storage system 226 may make metrics available to one or more client processes, such as an edge recommendation system 240. Edge recommendation system may, for example, be hosted by provider network 108 and may be used to provide recommendation(s) for particular edge site(s) where a customer should deploy network element(s). In examples, the edge recommendation system 240 may be accessed over one or more network connections by a client device 242.

In examples, if a customer (or potential customer) of a provider network, such as provider network 108, is interested in provisioning a network element in provider network 108, then the edge recommendation system 240 may be employed to determine (e.g., based on collected instances of metrics) a recommended edge site for the network element. In examples, the recommendation may be based on a variety of optimization criteria that may be selected, weighted, and/or ranked by the customer through a user interface provided by edge recommendation system 240 for display on client device 242. In addition, the edge recommendation system 242 may also receive (e.g., through user interface on client device 242) component information that describes the network element that the customer is interested in provisioning into provider network 108.

For example, edge recommendation system 242 may receive component information, such as the type of software application(s) to be executed, data storage requirements, operating system(s), network connectivity (e.g., public internet, private networking, hybrid, etc.), security requirements (e.g., particular security needed, such as payment card industry (PCI) security certification), latency requirements (e.g., maximum average latency), internet protocol (IP) addresses and/or destinations/entities that need to be reached, type of data traffic (e.g., voice, video) that will be sent to and from the service, and the physical location of customer site(s) that will be accessing the network element, etc.

The edge recommendation system 240 may also receive optimization criteria, such as performance, reliability (e.g., uptime), average latency between particular network elements, cost, security rating, etc. For example, a predetermined set of optimization criteria may be presented through a user interface to client device 242, and the user may be provided an opportunity to rank and/or weight the optimization criteria in terms of importance. In other examples, a standard set of optimization criteria may be used, or optimization criteria specific to a type of network element to be hosted may be used.

Edge recommendation system 240 may then determine the metrics that are relevant to a recommendation for an edge site. For example, edge site recommendation system 240 may examine the customer-supplied component information and the optimization criteria to determine which metrics that are captured by the provider network 108 are most relevant to determining the optimal edge site for the network element. In examples, the edge recommendation system 240 may determine metrics that are captured from capture agents associated with network elements that are similar to the network element described by the component information (e.g., same or similar type of workload, similar data transmission profile, same or similar type of device or device characteristics, etc.). The edge recommendation system 240 may also determine from the component information the location of customer site(s) that will access the network element and use that information in determining which previously collected metrics are most relevant for estimated latency determinations. Optimization criteria may also be used in determining the relevant metrics. For example, if the optimization criteria indicates that the customer wants to optimize on cost and latency, but omits security, then the relevant metrics may include only those needed to determine estimated cost and latency.

The capture component(s) (e.g., 214, 216, 220, 224) already operating in the network may be instrumented to collect the relevant metrics. For example, if an optimization criterion is average latency between a particular network elements, capture component(s) may be instrumented to capture latency information at relevant network elements and transmit instances of those metrics into the metrics storage system 226. Edge recommendation system 240 can then query the metrics storage system (e.g., through API(s) 228 and/or metrics presentation engine 230 for instances of relevant metrics stored in database clusters 232 and/or 234 to determine one or more optimized edge site(s) to recommend for a particular network element.

In examples, results of the recommendation process may be returned as a list of edge site candidates ordered according to the ranked and/or weighted optimization criteria, e.g., as the optimization criteria are selected and/or weighted/ranked by the customer. In some examples, the edge recommendation system 240 may employ a scoring matrix to score edge site candidates based on the ranked and/or weighted optimization criteria (and corresponding metrics). The list of edge site candidates may be presented to a user for selection of an edge site to host the network element. The list of edge site candidates may be presented along with underlying metrics for some or all of the optimization criteria so that a user can view, e.g., the estimated costs, performance, reliability, security rating, average latency, etc. associated with each of the edge site candidates in determining an edge site to choose. In examples, the list of edge site candidates may also be sortable by a user on any of the optimization criteria, among other things. For example, the list of edge site candidates may first be presented in ascending order of cost, but it may be then sorted by a user to be ordered in ascending order of estimated latency. In other examples, the list of edge site candidates may be used to cause the network element to be provisioned to a particular edge site (e.g., by directing the client device 242 to network utility 102).

Further, as discussed, a customer may delineate for particular metrics, access controls for the instances of the metrics that are captured using the capture component(s) 214, 216, 220, 224. In some examples, stored instances of metrics may be available to any client process that requests them. In other examples, the instances of metrics (once captured) may be accessed only by client processes that have permission to do so (e.g., using role-based access control (RBAC) or otherwise). Access to stored instances of metrics may be controlled, e.g., by metrics access control system 236. For example, a request from a client process (such as edge recommendation system 240) for metrics may be examined to determine whether the requesting process has the necessary permissions to view the requested instances of metrics. In some examples, certain metrics may be mandatorily required by the provider network 108 to be accessible at least to certain client processes, such as an edge recommendation system 240. In other examples, certain metrics may be kept private and accessible only to the customer that provisions the network element with which the capture component is provisioned. Other permission schemas are possible.

In some examples, algorithms may be executed by metrics presentation engine 230 and/or edge recommendation system 240 to determine one or more recommended edge site(s) based on stored instances of metrics. For example, one optimization criterion may be cost. Capture components 220 and 224 may be instrumented to capture metrics associated with cost (e.g., prices currently being charged to customers using edge sites 218 and 222, respectively, for a variety of network services). An algorithm implemented in edge recommendation system 240 and/or metrics presentation engine 230 may retrieve instances of raw metrics and correlate them to cost(s) that might be expected should a particular network element be provisioned at one or more of edge sites 218 and 222. In examples, the algorithm may take a variety of forms, such as a polling algorithm, a bidding algorithm, a sampling algorithm, machine-learning algorithms, a Nash-equilibrium bidding algorithm, etc. Details of some example algorithms are described below.

In examples, the edge recommendation system 240 may use the received component information and optimization criteria to decide relevant metrics to request from the metrics storage system 226. For example, a sophisticated edge recommendation system may be able to pattern match between the description of the network element that is to be provisioned (as described in the component information received from client 242) and the network elements from which metrics have been collected and stored in the metrics storage system 226.

For example, instances of metrics that are stored in metrics storage system 226 may be stored with an indication of the network elements from which they were derived. For example, each capture component (e.g., 220, 224) that is associated with a particular type of workload (application) may be instrumented to send instances of collected metrics into a database (e.g., 232, 234) that is specific to that type of workload. As such, if the edge recommendation system 240 receives a request to recommend a particular edge site to host that type of workload, then the edge recommendation system 240 may request metrics associated with that type of workload from the metrics storage system 226.

More complicated determinations of relevant metrics to request are also possible. For example, metrics storage system 226 may store/index information about workloads, workload types, data transfer profiles, hardware systems, operating systems, available bandwidth, server load, and any other environmental data related to the systems from which metrics instances are captured and stored in metrics storage system 226. Such information can then be used, e.g., by edge recommendation system 240 to granularly request metrics with the most relevance to the proposed provisioning of a new network element.

As such, if two different customers (e.g., using one or more client device 242) request a recommendation of an edge site to host a network element, and they provide different component information, then the relevant metrics that are determined by the edge recommendation system 240 and requested from the edge storage system 226 may be distinct. Further, even if two different customers provide very similar component information, different customers may provide different optimization criteria. For example, one customer may heavily weight the importance of latency, while another customer may heavily weight the importance of cost. Accordingly, whether or not the relevant metrics that are determined and requested from the metrics storage system 226 are the same or different, the edge recommendation system 240 may recommend different edge sites to different customer(s) (or rank the recommended candidate edge site(s) differently).

In examples, after a particular edge site is recommended by edge recommendation system 240, the customer (e.g., using client device 242) may select a particular site. The client device 242 may then be directed to network utility 102, and the network element may be provisioned (and instrumented for metrics collection) as described.

In examples, systems 100 and 200 of FIGS. 1 and 2 together may represent a metrics ecosystem of instrumenting network elements with capture components, collecting metrics using the capture components (e.g., 220, 224), and then presenting the metrics for use. Although the metrics instrumenting, capture, and presentation systems of the present application are discussed in an example where a customer is deploying a network element to an edge site, use of the metrics instrumenting, capture, and presentation systems are not so limited.

Examples of the metrics ecosystem described herein may include three artifact types: APIs, agents, and algorithms. This, coupled with a metrics storage mechanism for state collection, lifecycle and presentation of metrics enables the network customers to seamlessly integrate metrics capture into their respective applications.

The design pattern of the API (and possibly other components) of the application may be instrumented to event metrics back into a metrics storage system 226 using a CRUDLB (Create, Retrieve, Update, Delete, List, Bulk Write) REST-ful interface in a database that is subject to metrics access control system 236. This configuration is the default and automatic to every tenant application in provider network 108. Agents are involved when capture of metrics is required beyond the API or application runnables (e.g., when the network element being provisioned/configured is a network device 112 as opposed to a workload 114). Algorithms are involved for higher order concerns (e.g. Nash Equilibrium) beyond the typical scope of the API in simple collection of metrics.

Below is a collection of features of example APIs according to the present systems and methods:

Category Hierarchy, Adverb-Verb/Adjective-Noun Use Case Decomposition: The use case is distilled into and described as such in an API and command line interface (CLI). Categories are dynamically acted upon as appropriate in role-based access control (RBAC), security, routing, etc.
Pattern: /context category/version category/runnable category/(optional subcategory)/ . . . /adverb/verb/adjective/noun
Example Distilled: /api, algorithm, agent, etc. context category/version category/runnable category/adverb/verb/adjective/noun
Example of IoC Factory: /api/rest/edge/v1/lifecycle/provision/scale/across/iocfactory/regions

Universal End User Metric API (Server Side Edge Metrics Presentation Engine): An example of a Universal End User Metric API for every metric is shown below and can be customized per individual event by overriding $BODY environment variables/parameters. Service exposure constrained by RBAC and policy per metric (aka metrics database). In examples, this exists in the CRUDLB category of exposed API:
/v1/crudlb/create/edge/metrics/presentation/engine/metric
/v1/crudlb/retrieve/edge/metrics/presentation/engine/metric
/v1/crudlb/update/edge/metrics/presentation/engine/metric
/v1/crudlb/delete/edge/metrics/presentation/engine/metric
/v1/crudlb/list/databases/edge/metrics/presentation/engine/metric
/v1/crudlb/get/collection/names/edge/metrics/presentation/engine/metric
/v1/crudlb/bulk/write/edge/metrics/presentation/engine/metric

Universal End User Metrics API (All Runnables): An example of Universal End User Metric API subcategories for every runnable is shown below. The /keep /alive is used to manage failover for each component in this API first platform, the /inventory is for updating the Edge Metrics Ecosystem with its respective logical (e.g., Terraform Component Infrastructure) or virtual (VM Guest Workload) inventory. The /artifact is for returning detail on an underlying API that is a composite part of the called artifact based on content routable serial number. The /ping is used to exercise REST for secondary metrics collection option if the route using ICMP is unavailable. The rest may be used to report unique identity in the edge metrics ecosystem. Inventory update, in examples, will be no less than 24 hours per cron job and may be also ad hoc generated by exercising the respective REST interface of the given runnable for the same. Use of metrics may be two phase: to query the state in the edge metrics presentation engine 230 to orient the transaction and to again query the target /inventory during phase two of the transaction to ensure accuracy of metrics as/if needed by the use case.

/v1/<any>/keep/alive/<any>

/v1/<any>/inventory/<any>

/v1/<any>/artifact/<any>

/v1/<any>/stock/symbol/<any>

/v1/<any>/mal/<any>

/v1/<any>/serial/number/<any>

/v1/<any>/data/glyph/<any>

/v1/<any>/ping/<any>

Universal End User Artifact API: An example Universal End User Artifact API for every artifact is shown below and can be customized per individual event by specifying $BODY Bash-based algorithm to effect such. A uuencode may be used for binary to text conversion for transport in REST call. Service exposure constrained by RBAC and policy per artifact.

/v1/crud/create/edge/artifacts/global/load/balancer/artifact

/v1/crud/retrieve/edge/artifacts/global/load/balancer/artifact

/v1/crud/update/edge/artifacts/global/load/balancer/artifact

/v1/crud/delete/edge/artifacts/global/load/balancer/artifact

Translate from API LOGICAL to Edge PHYSICAL: API presentation may be based on logical pre-categorization of API artifacts to physical edge artifacts at an edge site like edge site 116. Example: an artifact logically manipulated in a cloud management platform may mean one physical configuration for one vendor and another physical configuration for another per their intended use.

Translate from API LOGICAL to Edge PHYSICAL: API presentation may be based on logical pre-categorization of API artifacts to physical edge artifacts at an edge site like edge site 116. Example: an artifact logically manipulated in a cloud management platform may mean one physical configuration for one vendor and another physical configuration for another per their intended use.

Translate from API GENERIC to Edge SPECIFIC: API presentation may be based on generic pre-manipulation of API artifacts to specific edge artifacts. Example: “Scale across regions” API may be manipulated in a cloud management platform across vendors to enable vendors to scale per their respective configuration.

In addition, capture agents may be downloaded from capture component repository 118 for use with a particular network element provisioned/configured at an edge site, such as edge site 116 and/or 126. For example, if the network element does not include a workload that can be directly instrumented, a separate capture agent may be used. In examples, the capture agents that are downloadable from the capture component repository 118 may have features to self-distribute and manage and may include plug and play abstraction to multiple backend telemetry (e.g., to support Openstack and VM Ware).

Further, in some examples, metrics capture algorithms may be implemented for edge-site recommendation decisions in higher-order metrics capture systems. Other algorithms are possible, and the following are only exemplary.

Events, Polling: In Band Edge Selection (Physical): Event Based Selection—events may be sent per specified criteria to a client-side workload. Client-side workload adjudicates events and thus edge selection per specified criteria. Polling (& Benchmarking, Scheduling) Based Selection—client-side workload polls (benchmarks or schedules) via global load balancer (e.g., Citrix) per specified criteria to capture components. Edge may be selected per standard Citrix mechanism.

Sampling: Out of Band Edge Presentation Engine Based Selection (Physical): Spatial (Random Field) Sampling Based Selection—Client-side workload polls via Citrix per specified criteria to capture component(s) in specified cardinality whereupon the specified “space” is sampled in the specified dimension with the metrics saved in a newly generated cache database via Citrix across all edge metrics presentation engines 230 with time-to-live (TTL) for initial metric collection. Thereafter the edge metrics presentation engine(s) 230 is/are queried first for captured metric and only performs above again per TTL expiry. Temporal (Point Process) Sampling Based Selection—client-side workload polls via Citrix per specified criteria to capture component(s) in specified cardinality whereupon the specified “point or plane” is sampled within the “space” in the specified dimension in the specified rate over the specified time with the metrics saved in a newly generated cache database via Citrix across all edge metrics presentation engines 230 with TTL for initial metric collection. Thereafter the edge metrics presentation engine(s) 230 is/are queried first for captured metric and only performs above again per TTL expiry.

Bidding: Out of band Edge Presentation Engine based edge selection (Logical): Standard Bidding Based Selection (Individual Competitive Bid)—client-side workload polls via Citrix per specified criteria to capture component(s) in specified cardinality whereupon the specified individual competitive “bid” is requested in the specified dimension. The target edge site (e.g., 218, 222) responds with instances of the metrics saved in a newly generated cache database via Citrix across all edge metrics presentation engines 230 with TTL for initial metric collection. Thereafter edge metrics presentation engine(s) 230 is/are queried first for captured metric and only performs above again per TTL expiry. Nash Equilibrium Based Selection (Zero Sum Game Theory/Community Coop-petition Bid)—Client-Side Workload polls via Citrix per specified criteria to capture component(s) in specified cardinality whereupon the specified community “bid” is requested in the specified dimension. The target edge sites (e.g., 218, 222) adjudicates bid between themselves using polling via Citrix per specified criteria for a specified time or end state to reach equilibrium. The target edge sites (e.g., 218, 222) then respond with the metrics saved in a newly generated cache database across all edge metrics presentation engines 230 with TTL for initial metric collection. Thereafter the edge metrics presentation engine(s) 230 is/are queried first and only performs above again per TTL expiry.

Machine Learning: Out of Band Edge Presentation Engine based Edge Selection (Physical): With respect to machine learning, a possible use case here is edge site selection. Therefore, any state maintained for machine learning algorithms may reside in the metrics storage system 226 behind the edge metrics presentation engine(s) 230. Likewise, machine learning inference may require a tool like Python to compute such. Therefore, Python algorithms may still be called from the respective Spring Boot 4 (blocking) or 5 (non-blocking) selection agent whose results will still be stored in a newly generated cache database across all edge metrics presentation engines 230.

Prediction/Projection Based Selection (Absolutes): Appropriate machine learning mechanisms may be introduced with metrics “absolutes” saved in a newly generated cache database via Citrix across all edge metrics presentation engines 230 with TTL for initial (and/or ongoing) metrics collection. Thereafter the edge metrics presentation engine(s) 230 is/are queried first and only performs above again per TTL expiry.

Probability Based Selection (Likelihood): Appropriate machine learning mechanisms may be introduced with metrics “likelihood” saved in a newly generated cache database via Citrix across all edge metrics presentation engine(s) 230 with TTL for initial (and/or ongoing) metrics collection. Thereafter the edge metrics presentation engine(s) 230 is/are queried first and only performs above again per TTL expiry.

Inventory: Out of Band Edge Presentation Engine based Edge Selection: Inventory Client Side/or Edge Side Agent Based Selection—Appropriate edge capture agent metrics are captured as appropriate for edge site selection per specified inventory criteria.

Composite: Out of Band Edge Presentation Engine based Edge Selection: Composite Client Side and/or Edge Side Agent Based Selection—Appropriate edge capture agent metrics are combined with metrics evaluated as appropriate for edge selection per specified criteria.

CRUDLB: Out of Band Edge Presentation Engine based Edge Selection: Client Side and/or Edge Side Agent Based Selection—Appropriate CRUDLB edge capture agent mechanisms are introduced with metrics saved in a newly generated cache database via Citrix across all edge metrics presentation engines 230 with TTL for initial (and/or ongoing) metrics collection. Thereafter the edge metrics presentation engine(s) is/are queried first and only performs above again per TTL expiry. In examples, all other Agents may be based on this agent.

In certain examples, the metrics storage system 226 may comprise a multi-application-tenant database platform is by default shared between tenant applications within a master application list (MAL) with individual databases aligned with each. For example, this may be referred to as the “Small” T-Shirt configuration. Likewise, if need arises, the backend database platform can instead be multi-tenant between MALs and managed by operators independently. For use cases requiring elevated performance and single application tenancy, other T-Shirt sized databases are available as described next. In the following example, “Mongo” is the database system employed, e.g., by metrics storage system 226.

```
      Metrics T-Shirt Sizing
Small: (Persistence profile is CACHE)
  Multi-application-tenant x3 replica set
  Default TTL for DB and Document
  No Backup
  Standard SLAs
    DB TTL 91 days
    Document TTL 25 hours
  REST API access only, connection per transaction
  No Canned Decision
  Default Cedexis routing
  Default Deployment Topology
  Default Scale
v500 GB /data
  Native Application Authentication & Authorization
  CRUDLB API based on Mongo CLI
  Not a system of record
  No Partial Word Match
  Flock( ) based Reactive backend behavior
  Public network API exposure only
Large: (Persistence profile is DB)
  MAL single-application-tenant x5 distributed replica set
  Custom TTLs for DB and Document
  Custom Backup
  Custom SLAs
  Custom DNS
  Custom Cedexis routing
  Custom Deployment Topology
  Custom Scale (may require K8 Operator)
  Canned Decision available
  Canned CRUBLB Spring Boot based API access
  mongod://access, message broker API access, replaces REST
  Persistent Mongo client connection
  500 GB /data
  SAML based Authentication & Authorization
  Possible system of record
  Advanced Reactive backend behavior tooling (Scala, Reactive Streams, etc)
  Custom Private network API exposure available
```

NXL:

Large configuration×N 500 GB/data shards

Mongo DB & Collection TTL: In Small T-Shirt only, Mongo may be treated exclusively as a cache with a TTL for the given DB and collections within the DB. It may be considered an exception to not have these TTLs set on a given database. This may minimize maintenance issues and economize on infrastructure for general use cases in addition to allowing massive scale globally (as the platform will be pretty much maintenance free). Higher order use cases needing ongoing DB persistence may migrate to larger T-Shirt size instances. More often than not, the Small T-Shirt sized configuration will be adequate.

Reactive Mongo, Partial word Matching: In T-Shirt sizes above Small, Reactive Mongo drivers can be introduced to implement non-blocking behavior in two dimensions. The first may be used to synch Mongo with Elastic Search for partial word matching using the Scala non-blocking driver that is used to sychronize with ES. Beyond ES synchronization, the Mongo Java Reactive Streams driver can be introduced to implement reactive behavior when implemented in a given use case.

Mongo Change Streams and Metrics Thresholding: Mongo Change streams may be used to threshold against “strategic” metrics (those whose metrics transacted to the Mongo database per automatic participation in the edge metrics ecosystem that have the same threshold across instances) so as to provide a universal monitoring and alarming system strategically across all instances. Tactical metrics can still be thresholded individually per runnable and use the same alarming by using the keyword “alarm” which may also be thresholded for. While latency is one default metric, any metric can be stored in Mongo and thus thresholded against.

Kubernetes Operator for MongoDB: Where Kuberenetes is available a Percona Kubernetes Operator may be swapped for Percona Server for MongoDB for massive scale with limited DB function (than otherwise experienced using internal Mongo automation based on VM Guests).

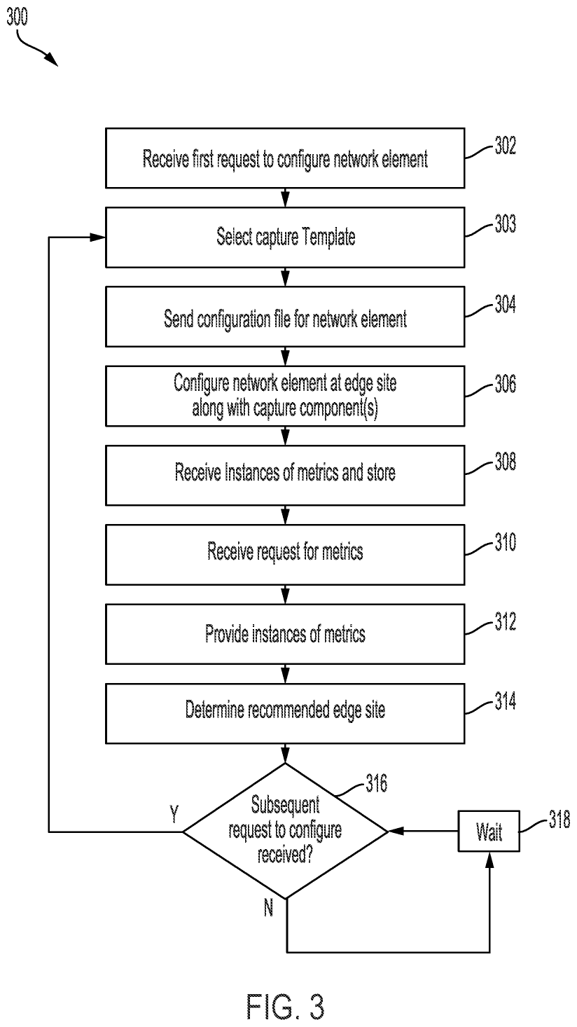

FIG. 3 depicts an example method 300 for instrumenting network elements with capture component(s) per examples described herein. At operation 302, a first request to configure a network element at a first network edge site is received. In examples, the request may be received at network utility 102 from a first customer using a first client device (e.g., client device 110). In examples, the network element may comprise at least one of a first network device and a first workload.

In examples, flow proceeds to operation 303, where a capture template is selected. In examples, operation 303 may comprise determining whether the network element is of a similar type to a previously provisioned network element. If so, then a capture template for that particular type of network element may be selected. If not, a default capture template may be selected. Other methods of selecting a capture template are possible.

Flow proceeds to operation 304, where a first configuration file for the network element is sent. In examples, the first configuration file may be sent by network utility 102 to client device 110. In examples, the first configuration file includes a first capture template for metrics collection selected at operation 303. For example, the first capture template may comprise a command line runner and an instrumentation template (e.g., when the network element comprises a workload). In other examples, the capture template may comprise a capture agent template (e.g., when the network element comprises a network device).

Flow proceeds to operation 306, where a first network element is configured at the first edge site. In examples, a first capture component is configured and installed with the provisioned network element. The first capture component may comprise a refactored version of the first capture template. For example, the customer may customize the first capture template to capture metrics of particular interest at the network element. In addition, the capture component may be stored (e.g., in capture component repository 118) for future use as a capture template.

In some examples, the capture component may include a parameter that indicates permissions for access to metrics captured by that capture component. A metrics access control system (e.g., 236) may check such permissions before allowing access to the metrics captured by that capture component. In some examples, the permissions are controllable by the customer; however, in some examples, the configuration file may specify a set of mandatory metrics, such that the first network element is provisioned at the first network edge site only when the first capture component is instrumented to collect the set of mandatory metrics.

Further, capture components, in some examples, may be configured to participate in one or more metrics capture algorithms, such as a Nash equilibrium algorithm, a bidding algorithm, a polling algorithm, a sampling algorithm, a prediction algorithm, a machine-learning algorithm, or a probability algorithm. Algorithms may be carried out by one or more of the capture component, a metrics presentation system (e.g., 230), and/or a client process such as an edge recommendation system 240.

Flow proceeds to operation 308, where instances of metrics from the first capture component of the first network element are received at a metrics storage system. For example, instances of metrics form a capture component (e.g., 220) may be received at metrics storage system 226. The metrics storage system 226 may store the received instances of metrics, e.g., in database(s) 232, 234.

Flow proceeds to operation 310, where a request for the metrics is received. For example, metrics storage system 226 may receive a request from edge recommendation system 240 or another client process to return instances of the metrics. At operation 312, the instances of metrics are provided, e.g., to the edge recommendation system 240.

Continuing in the example where the metrics are requested/received by an edge recommendation system, flow proceeds to operation 314, where a recommended edge site is determined. For example, a customer (e.g., using client device 242) may request a recommendation for an edge site at which a second workload will be provisioned/configured to run. At operation 314, the recommendation may be returned, e.g., by edge recommendation system 240 to client device 242.

In examples, flow may proceed to decision operation 316, where a determination is made whether another request to configure a network element has been received. If so, flow may proceed back to operation 303, where the process is repeated for the second (or subsequent) network element to be provisioned/configured at a second edge site. For example, a second client 120 may issue a request from a second customer that a second network element (e.g., network device 124 or workload 122) be provisioned on edge site 126. If no subsequent request has been received, flow may proceed to a wait operation 318 until another request is received.

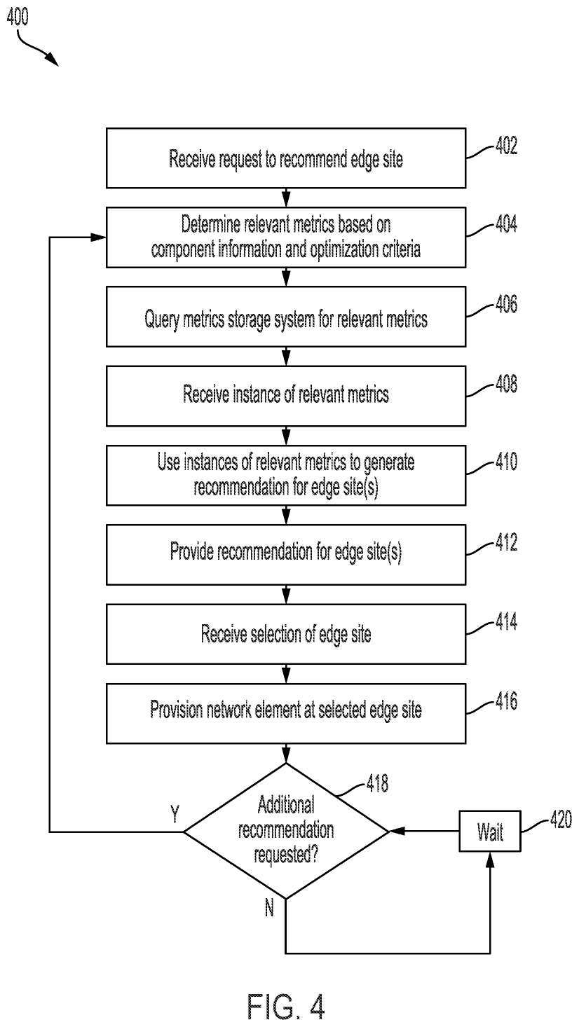

FIG. 4 depicts an example method 400 for recommending an edge site for provisioning a network element within a computing network. In nonexclusive examples, some or all operations of the method 400 may be performed by an edge recommendation system, such as edge recommendation system 240. Flow begins at operation 402, where a request to recommend a network edge site is received. In examples, the request may be from a first customer desiring to configure a first network component (such as a network device or workload) in a provider network. In examples, the request includes both first component information and first optimization criteria. For example, the component information may comprise information about the network element to be configured and the customer site(s) that will access the network element. Optimization criteria may comprise factors for which the customer desires the edge site selection to be optimized, such as latency, cost, security, etc. In examples, the optimization criteria may also be provided to the edge recommendation system 240 with a weighting or ranking of the criteria entered by the customer to indicate the relative importance of the different criteria to the customer.

Flow proceeds to operation 404, where relevant metrics are determined based on the first component information and the first optimization criteria. For example, an edge site recommendation system (e.g., edge site recommendation system 240) may examine the first component information and the first optimization criteria to determine which metrics that are captured by the provider network are most relevant to determining the optimal edge site for the network element. In examples, the edge recommendation system 240 may determine metrics that are captured from deployed capture agents associated with network elements that are similar to the network element described by the component information (e.g., same or similar type of workload, similar data transmission profile, same or similar type of device or device characteristics, etc.). The edge recommendation system 240 may also determine from the component information the location of customer site(s) that will access the network element and use that information in determining which previously collected metrics are most relevant for, e.g., estimated latency determinations. Optimization criteria may also be used in determining the relevant metrics. For example, if the optimization criteria received at operation 402 indicates that the customer wants to optimize on cost and latency, but omits security, then the relevant metrics may include only those needed to determine estimated cost and latency.

Flow proceeds to operation 406, where a metrics storage system is queried for the relevant metrics. For example, edge recommendation system 240 may query metrics storage system 226 for the relevant metrics through AIP(s) 228. In examples, the metrics storage system 226 stores instances of the relevant metrics from other network elements operating on the provider network. In examples, querying the metrics storage system 226 for relevant metrics may cause an algorithm (or portion thereof) to be executed by metrics presentation engine 230 to provide some or all of the relevant metrics.

Flow proceeds to operation 408, where instances of the relevant metrics are received. For example, in response to the query in operation 406, the edge recommendation system 240 may receive instances of the relevant metrics from metrics storage system 226.

Flow proceeds to operation 410, where the instances of the relevant metrics are used to generate a recommendation of at least one edge site within the provider network. For example, edge recommendation system 240 may use the instances of the relevant metrics, in combination with the ranking/weighting of the optimization criteria received from the customer, to determine one or more recommended edge sites within network 108. For example, the edge recommendation system 240 may generate a list of edge site candidates ranked according to the ranked and/or weighted optimization criteria, e.g., as the optimization criteria are selected and/or ordered by the customer. In some examples, the edge recommendation system 240 may employ a scoring matrix to score edge site candidates based on the ranked and/or weighted optimization criteria (and corresponding metrics). Edge recommendation system 240 may also consult other data sources (such as an inventory system) to determine whether particular edge sites have necessary computing capacity, bandwidth, security certifications, etc., and/or whether they could be upgraded to meet such requirements of the customer.

At operation 412, the recommendation is provided. For example, the edge recommendation system 240 may provide the recommendation (e.g., an ordered list of candidate edge sites) to client 242. The list of edge site candidates may be presented to a user for selection of an edge site to host the network element. The list of edge site candidates may be presented along with underlying metrics instances for some or all of the optimization criteria so that a user can view, e.g., the estimated costs, performance, reliability, security rating, average latency, etc. associated with each of the edge site candidates in determining an edge site to choose. In examples, the list of edge site candidates may also be sortable by a user on any of the optimization criteria, among other things. For example, the list of edge site candidates may first be presented in ascending order of cost, but it may be then sorted by a user to be ordered in ascending order of estimated latency.

Flow proceeds to operation 414, where a selection of an edge site is received. For example, the customer may select (e.g., through a user interface presented on client device 242) one of the recommended edge sites. At operation 416, the network element may be provisioned at the selected edge site. The client device 242 may then be redirected, e.g., to network utility 102 to being the provisioning process for the network element. For example, the network element may be provisioned (at least in part) and instrumented for metrics collection using the method 300.

Flow proceeds to decision operation 418, where a determination is made whether another (e.g., second or subsequent) request is received for an edge site recommendation. If so, flow loops back to operation 404, where the process is repeated for the second (or subsequent) recommendation to be made (e.g., for a second customer desiring to configure a second network element at a second edge site). For example, a second client device 242 may issue a request from a second customer for a recommendation relating to a second network element being provisioned in network 108. In examples where the component information and/or optimization criteria are different from the first request, the edge recommendation system 240 may recommend a different edge site to the second customer. If no subsequent request has been received, flow may proceed to a wait operation 420 until another request is received.

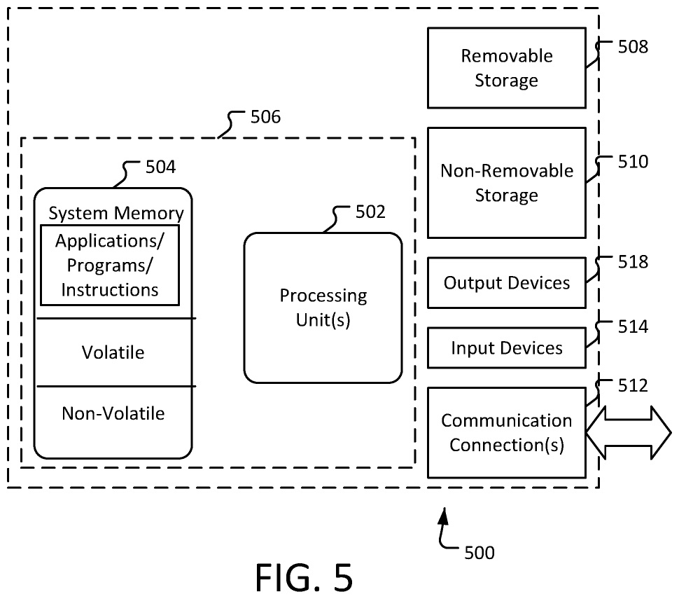

FIG. 5 depicts an example environment 500 with which aspects of the present systems and methods may be practiced. For example, one or more of client devices 110, 120, 210, 212, 242, network utility 102, capture component repository 118, edge sites 116, 126, 218, 222, metrics storage system 226, and edge recommendation system 240 can take the form, in whole or in part, of environment 500 in FIG. 5.

In its most basic configuration, operating environment 500 typically includes at least one processing unit 502 and memory 504. Depending on the exact configuration and type of computing device, memory 504 (storing, instructions to perform the techniques disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections 512, such as LAN, WAN, point to point, etc. In embodiments, the connections may be operable to facility point-to-point communications, connection-oriented communications, connectionless communications, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which may be exhibited by some examples and not by others.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

We claim:

1. A method for capturing metrics in a network, comprising:
receiving, at a network utility and from a client device, a first request to configure a network element at a first network edge site for a first customer, wherein the first network element comprises at least one of a first network device and a first workload;
sending, by the network utility, at least a first configuration file for the first network element, wherein the first configuration file comprises a first capture template for metrics collection;
configuring the first network element at the first network edge site, including a first capture component that comprises a refactored first capture template;
receiving, at a metrics storage system, instances of metrics from the first capture component of the first network element;
receiving a request for the metrics at the metrics storage system; and
providing the instances of the metrics.

2. The method of claim 1, wherein the request for the metrics is received from, and the instances of metrics are provided to, an edge recommendation system, the method further comprising:
determining, by the edge recommendation system, a recommended edge network site for a second workload of a second customer;
providing the recommended edge network site for the second workload to the second customer.

3. The method of claim 2, the method further comprising:
storing the first capture component in a capture component repository;
receiving, at the network utility and from a second client device, a second request to configure a second network element at the second network edge site for the second customer, wherein the second network element comprises at least one of a second network device or the second workload;
sending, by the network utility, a second configuration file for the second network element, wherein the second configuration file comprises a second capture template for metrics collection; and
configuring the second network element at the second network edge site, including a second capture component that comprises a refactored second capture template.

4. The method of claim 3, further comprising:
in response to receiving the second request, determining that the second network element is of a similar type to the first network element;
wherein sending the second configuration file comprises generating the second capture template based on the first capture template.

5. The method of claim 1, wherein when the first network element is the network device, the first capture component is a capture agent, and when the first network element is the first workload, the first capture component is an embedded API in the first workload.

6. The method of claim 1, wherein the network utility is an internet of components (IoC) factory.

7. The method of claim 4, wherein the first capture component comprises a parameter that indicates permissions regarding access to the instances of the metrics from the first capture component, further comprising:
checking the permissions before providing the instances of the metrics.

8. The method of claim 1, wherein the first configuration file specifies a set of mandatory metrics, further comprising: configuring the first network element at the first network edge site only when the first capture component is instrumented to collect the set of mandatory metrics.

9. The method of claim 1, wherein the first capture component comprises a command line runner and an instrumentation template.

10. The method of claim 2, wherein the first capture component is configured to participate in at least one algorithm of the following algorithms used in determining the recommended edge network site:
a Nash equilibrium algorithm;
a bidding algorithm;
a polling algorithm;
a sampling algorithm;
a prediction algorithm; or
a probability algorithm.

11. The method of claim 10, wherein the at least one algorithm is executed in part by a metrics presentation engine.

12. A method for recommending a network edge site, the method comprising:
receiving, from a first client device, a first request to recommend a network edge site within a provider network to configure a first network element for a first customer, wherein the first network element comprises at least one of a first network device and a first workload, and wherein the request includes first component information and first optimization criteria;
determining, based on the first component information and the first optimization criteria, first relevant metrics;
querying a metrics storage system for the first relevant metrics, wherein the metrics storage system stores instances of the first relevant metrics from other network elements operating on the provider network;
receiving the instances of the first relevant metrics;
using the instances of the first relevant metrics to generate a recommendation of at least a first network edge site for the first network element; and
providing the recommendation to the first client device.

13. The method of claim 12, further comprising:
receiving a selection of the first network edge site;
configuring the first network element for the first customer at the first network edge site.

14. The method of claim 12, further comprising:
receiving, from a second client device, a second request to recommend a network edge site within the provider network to configure a second network element for a second customer, wherein the second network element comprises at least one of a second network device and a second workload, and wherein the request includes second component information and second optimization criteria;
determining, based on the second component information and the second optimization criteria, second relevant metrics that are different from the first relevant metrics;
querying the metrics storage system for the second relevant metrics, wherein the metrics storage system stores instances of the second relevant metrics from other network elements operating on the provider network;
receiving the instances of the second relevant metrics;
using the instances of the second relevant metrics to generate a recommendation of at least a second network edge site for the second network element; and
providing the recommendation to the second client device.

15. The method of claim 12, wherein the first relevant metrics are specific to a type of the first network element.

16. A system, comprising:
at least one processor; and
memory, operatively connected to the at least one processor and storing instructions that, when executed by the at least one processor, cause the system to perform a method, the method comprising:
receiving, at a network utility and from a client device, a first request to configure a network element at a first network edge site within a provider network for a first customer, wherein the first network element comprises at least one of a first network device and a first workload;
sending, by the network utility, at least a first configuration file for the first network element, wherein the first configuration file comprises a first capture template for metrics collection;
configuring the first network element at the first network edge site, including a first capture component that comprises a refactored first capture template;
storing, at a metrics storage system, instances of first metrics from the first capture component of the first network element;
receiving, from a second client device, a request to recommend a network edge site within the provider network to configure a second network element for a second customer, wherein the second network element comprises at least one of a second network device and a second workload, and wherein the request to recommend includes component information and optimization criteria;
determining, based on the component information and the optimization criteria, relevant metrics;
querying the metrics storage system for the relevant metrics;
receiving the instances of the relevant metrics;
using the instances of the relevant metrics to generate a recommendation of at least a second network edge site for the second network element; and
providing the recommendation to the second client device.

17. The system of claim 16, wherein the relevant metrics include at least some of the first metrics.

18. The system of claim 16, wherein determining the relevant metrics comprises comparing the component information to information about the first network element, and when the component information matches at least a portion of the information about the first network element, determining that the relevant metrics includes at least some of the first metrics.

19. The system of claim 16, wherein the method further comprises:
storing the first capture component in a capture component repository;
receiving, at the network utility and from the second client device, a second request to configure the second network element at the second network edge site for the second customer;
sending, by the network utility, a second configuration file for the second network element, wherein the second configuration file comprises a second capture template for metrics collection; and
configuring the second network element at the second network edge site, including a second capture component that comprises a refactored second capture template.

20. The system of claim 19, wherein the method further comprises:
in response to receiving the second request, determining that the second network element is of a similar type to the first network element;
wherein sending the second configuration file comprises generating the second capture template based on the first capture template.
